(19) United States
(12) Patent Application Publication
(10) Pub. No.: US 2011/0084162 A1
(43) Pub. Date: Apr. 14, 2011

(54) Autonomous Payload Parsing Management System and Structure for an Unmanned Aerial Vehicle

(75) Inventors: Emray Goossen, Albuquerque, NM (US); Katherine Goossen, Albuquerque, NM (US)

(73) Assignee: HONEYWELL INTERNATIONAL INC., Morristown, NJ (US)

(21) Appl. No.: 12/576,583

(22) Filed: Oct. 9, 2009

(51) Int. Cl. B64C 29/00; G01M 1/12; B64C 17/10; B64D 37/14; B64C 1/14; B64C 1/38

(52) U.S. Cl. 244/12.1; 701/124; 244/135 C; 244/129.5; 244/137.1

(57) ABSTRACT

An unmanned aerial vehicle (UAV) for making partial deliveries of cargo provisions includes a UAV having one or more ducted fans and a structural interconnect connecting the one or more fans to a cargo pod. The cargo pod has an outer aerodynamic shell and one or more internal drive systems for modifying a relative position of one or more cargo provisions contained within the cargo pod. Control logic is configured to, after delivery of a partial portion of the cargo provisions contained within the cargo pod, vary a position of at least a portion of the remaining cargo provisions to maintain a substantially same center of gravity of the UAV relative to a center of gravity prior to delivery of the partial portion. Other center of gravity compensation mechanisms may also be controlled by the control logic to aid in maintaining the center of gravity of the UAV.

### BACKGROUND

1. Field of the Invention

The present invention relates, in general, to the field of autonomous payload parsing management. More specifically, it is directed to the field of UAVs capable of autonomously making partial deliveries of payloads.

2. Description of the Related Art

An unmanned aerial vehicle (UAV) is an unpiloted and/or remotely controlled aircraft. UAVs can be either remotely controlled or flown autonomously based on pre-programmed flight plans or more complex dynamic automation and vision systems. UAVs are currently used in a number of military roles, including reconnaissance and attack scenarios. An armed UAV is known as an unmanned combat air vehicle (UCAV).

UAVs are often preferred for missions that are too dull, dirty, dangerous, or expensive for manned aircraft. For example, a UAV may also be used to deliver a payload to a division stationed in hostile or non-hostile territory. Payloads may be comprised of provisions such as food and fuel and may be delivered to a location in or near enemy territory. The use of UAVs to make such deliveries reduces any threat of harm that was previously imposed on manned re-supply missions, for example.

There are a wide variety of UAV shapes, sizes, configurations, and characteristics. Modern UAVs are capable of controlled, sustained, level flight and are powered by one or more jets, reciprocating engines, or ducted fans.

External payloads carried by UAVs may further include an optical sensor and/or a radar system. A UAV's sophisticated sensors can provide photographic-like images through clouds, rain or fog, and in daytime or nighttime conditions; all in real-time. A concept of coherent change detection in synthetic aperture radar images, for example, allows for search and rescue abilities by determining how terrain has changed over time. The ability to deliver provisions under the cover of darkness, rain, or fog further improves the ability to reach deeply entrenched forces with additional supplies while minimizing the opportunities for opposing forces to intercept the re-supply vehicle.

Providing vertical takeoff and landing (VTOL) capability to a UAV further improves portability and allows a UAV to maneuver into situations and be utilized in areas that a fixed-wing aircraft may not.

### SUMMARY

While UAV's have been utilized extensively in reconnaissance roles, their use in re-supplying forces has been limited due to cost concerns and underdeveloped capabilities on the part of the UAV and the UAV payload.

As shown in FIG. 1, UAV-based deliveries may be made by sling-load, in which a ducted-fan UAV 2, for example, may deliver payloads 4 carried in a suspended sling 6 to a target supply destination. The design of the sling 6 requires that the payload 4 be of a fixed, pre-defined size. The sling 6 may be connected to the UAV 2 via a detachable ring connection at a center of gravity position 8 of the UAV 2. The sling configuration has a number of drawbacks, however. First, for example, the sling 6 and load 4 must be manually connected and disconnected from the UAV, therefore requiring human presence to load and unload the payload 4 from the sling 6. Furthermore, the suspended sling 6 substantially increases the overall size of the delivery vehicle and is prone to interference by tall trees and buildings, radio towers, and other obstacles that may be difficult to detect and/or maneuver around. Finally, the sling 6 configuration requires additional flights to each added supply destination, thereby also increasing chances of detection and/or destruction by enemy forces and increasing fuel usage and costs.

The present application is directed to an autonomous payload parsing management system that provides for an ability to make partial payload deliveries of variable package size. The system also provides for the autonomous ejection of a partial delivery at each of several supply locations, and to adjust a center of gravity of the unmanned aerial vehicle (UAV) as partial deliveries are made.

A UAV payload management system and cargo pod is provided, attachable and detachable from the UAV, and formed in an aerodynamic shape to support high-speed payload delivery. Autonomous payload delivery is provided via retractable clam-shell doors covering an opening at a rear of cargo pod and an internal drive system that can move variably-sized cargo provisions to an ejection point at the rear of the cargo pod. An additional squeeze actuator system may be provided on the drive system to aid in grapping onto, retaining, and eventually ejecting the cargo provisions. This squeeze actuator may consist of belt positioned bladders filled with air or with a liquid so as to expand and apply pressure to variable size cargo containers.

As autonomous partial payload deliveries are made, an internal drive system may cause a further internal re-adjustment of remaining cargo provisions to maintain a same or substantially similar center of gravity of the UAV as before the partial payload delivery. Additional center of gravity modification mechanisms may also be provided to compensate for center of gravity changes due to partial deliveries. For example, a plurality of disparately placed fuel tanks along an inside or outside surface of the cargo pod could hold a fuel, and pumps could be used to move the fuel from one fuel tank to another to maintain a center of gravity of the UAV after a partial delivery.

The cargo provisions stored in the cargo pod may be, for example, food, water, ammunition, repair parts, medical gurneys, clothing, or any other item that may need to be delivered to a remote location.

Payload management system control logic for monitoring a center of gravity and executing center of gravity adjustments may be disposed in a UAV skeletal structure portion of the UAV or in the cargo pod portion of the UAV. A UAV for supporting the cargo pod and payload management system may be, for example, a dual-ducted vertical take-off and landing (VTOL) UAV having a skeletal structural frame interconnecting the two ducts. Each duct may be provided with a petroleum-powered or electric-powered engine. The ability to implement vertical take-off and landing further improves the versatility of the delivery vehicle, allowing the vehicle to be used in, for example, dense urban areas.

Other features and further scope of applicability of disclosed embodiments are set forth in the detailed description to follow, taken in conjunction with the accompanying drawings, and will become apparent to those skilled in the art.

### BRIEF DESCRIPTION OF THE DRAWINGS

FIG. 1 is a perspective review of an Unmanned Aerial Vehicle (UAV)-based sling delivery system.

FIG. 2 is a perspective view of an example UAV mission carried out by a UAV enhanced with a cargo pod and an autonomous payload-parsing system according to one embodiment.

FIG. 3 is a detailed perspective view of an example UAV with an attached autonomous cargo pod and payload-parsing system.

FIG. 4 is a detailed perspective view of an example internal structure of the autonomous cargo pod and payload-parsing system.

FIGS. 5(a) and 5(b) illustrate front and side layout views of an example belt system drive structure that may be contained within the autonomous pod and payload-parsing system.

FIGS. 6(a)-6(c) illustrate example cargo provision loading configurations for the autonomous pod and payload-parsing system.

FIGS. 7(a)-7(d) illustrate example operation of the clamshell doors of the autonomous pod and payload-parsing system during a partial delivery.

FIG. 8 is a perspective view of an example UAV with the attached autonomous pod and payload-parsing system in the vertical landing position.

FIG. 9 is a perspective view of an example UAV with the attached autonomous pod and payload-parsing system in a stowed configuration.

FIG. 10 illustrates an alternative embodiment in which the autonomous pod is configured with one or more gurneys that are rotatably connected to the inside of the autonomous pod.

FIG. 11 illustrates an example control circuit for receiving center of gravity information from sensors placed about the UAV and for driving one or more center of gravity compensation systems.

FIGS. 12(a)-12(b) illustrate example center of gravity variations in a UAV with the attached autonomous pod and payload-parsing system prior to compensation by the control circuit of FIG. 11.

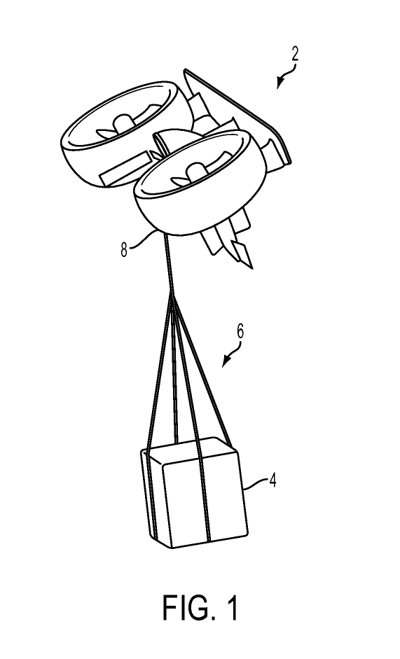

### DETAILED DESCRIPTION

### i. Overview

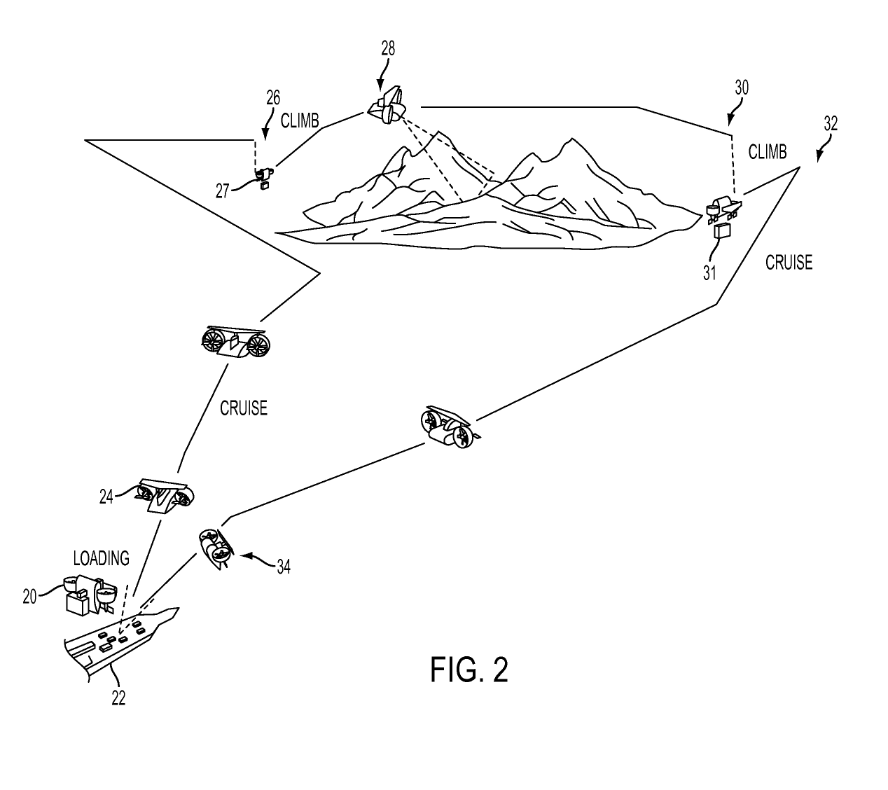

Aspects of the present application describe an autonomous payload parsing management system and structure for an unmanned aerial vehicle (UAV). FIG. 2 sets forth an exemplary mission that an example UAV with attached autonomous payload parsing management system and structure is configured to perform. A UAV 20 is capable of making partial payload deliveries at a plurality of supply locations, instead of being limited to a single full payload delivery at a single supply location, for example.

As shown in FIG. 2, the UAV 20 with an attached autonomous payload parsing management system and structure may be loaded with a plurality of separately-packaged payload cargo provisions at a staging location 22 while the UAV is in a vertical “landed” position. The staging location 22 may be, for example, an aircraft carrier as illustrated in FIG. 2. Of course, land or air-based staging locations may also be used.

After the cargo provisions are loaded into the UAV 20, the UAV 20 may execute a vertical take-off procedure and, at a point 24, begin to rotate from the vertical take-off position to a horizontal cruise position. The horizontal cruise position allows the UAV 20 to travel at a significantly higher rate of speed compared to the vertical take-off position or an intermediate position between vertical and horizontal. The UAV 20 could be pre-programmed with particular destinations to deliver the supplies to, and may fly autonomously using GPS or some other geographic tracking technology to execute autonomous flight to a first supply location. Alternately, the UAV 20 may be remotely controlled and may execute the flight maneuvers provided to it by the remote control to arrive at the first supply location.

In either situation, the UAV 20 may begin rotating from the horizontal cruise position back to the vertical take-off and landing position at point 26 as the UAV 20 approaches the first supply location 27. The UAV 20 may then land at the first supply location 27 under autonomous control (using optical and/or radio-frequency based sensors) or may land under remote control. The UAV 20 may then deposit a partial payload delivery by opening a rear portion of the cargo pod and dropping one or more (but less than all) of the cargo provisions stored in the cargo pod. The cargo provisions may be dropped, for example, via an internal drive system such as a belt drive system that rotates to cause the one or more of the cargo provisions to be dropped from a rear of the cargo pod.

After the first partial payload delivery of cargo provisions at the first supply location 27, the UAV 20 may then execute a center of gravity compensation procedure to maintain substantially a same center of gravity after the partial delivery as before the partial delivery. The compensation procedure may include, for example, re-adjusting the remaining cargo provisions within the cargo pod to effect a change in the center of gravity of the overall UAV 20. Alternately or additionally, the compensation may include pumping a fuel from one or more fuel tanks disparately placed about the UAV 20 to effect a change in the center of gravity of the overall UAV 20.

The UAV 20 may then execute another vertical take-off procedure after executing the center of gravity compensation procedure, and after climbing to a cruise altitude, may again rotate into a horizontal flight cruise position at point 28. The UAV 20 may fly from the first supply location 27 to the second supply location 31 autonomously by utilizing a GPS location of the UAV 20 and the second supply location 31. Alternately, as set forth earlier, the UAV 20 may fly from the first supply location 27 to the second supply location 31 under remote control by a user located remotely from the UAV 20 and the second supply location 31.

As the UAV 20 approaches the second supply location 31, the UAV 20 may again rotate into a vertical take-off and landing position at point 30. The UAV 20 may then land at the second supply location 31 under autonomous or remote control. After landing, the UAV 20 deposits another partial payload delivery (including, potentially, the remainder of the payload) by opening a rear portion of the cargo pod and dropping one or more of the cargo provisions stored in the cargo pod. The cargo provisions may be dropped via a same or similar process as at the first supply locations 27.

If desired, additional cargo provisions may be loaded into the UAV 20 at supply location 31. For example, assuming the cargo pod is now empty, a medical gurney with injured personnel may be loaded into the UAV 20 for transport back to the originating staging location 22. Of course, other cargo provisions could be loaded instead, including, for example, food, clothing, or ammunition for delivery to a third supply location (not shown).

After unloading some or all of the cargo provisions at the second supply location 31, and optionally taking in additional cargo provisions, the UAV 20 may execute a second center of gravity compensation procedure to maintain substantially a same center of gravity after the partial delivery (and optional pickup) as before the partial delivery (and optional pickup). Similar to the first compensation procedure, the second compensation procedure may include re-adjusting the remaining cargo provisions (or added cargo provisions) within the cargo pod to effect a change in the center of gravity of the overall UAV 20. Alternately or additionally, the second compensation may include pumping remaining fuel from one or fuel tanks disparately placed about the UAV 20 to effect a change in the center of gravity of the overall UAV 20.

The UAV 20 may then execute a final vertical take-off procedure after executing the second center of gravity compensation procedure, and after climbing to a cruise altitude, may again rotate into a horizontal flight cruise position at point 32. The UAV 20 may fly from the second supply location 31 back to the originating staging location 22 autonomously by utilizing a GPS location of the UAV 20 and the originating staging location 22. Alternately, as set forth earlier, the UAV 20 may fly from the second supply location 31 to the originating staging location 22 under remote control by a user located remotely from the UAV 20.

By providing for a UAV 20 having a capability to make partial payload deliveries and to re-adjust a center of gravity after each partial delivery, a more robust, safe, and cost effective re-supply mechanism may be provided.

### ii. Structure of the UAV With Attached Autonomous Payload Parsing Management System and Structure

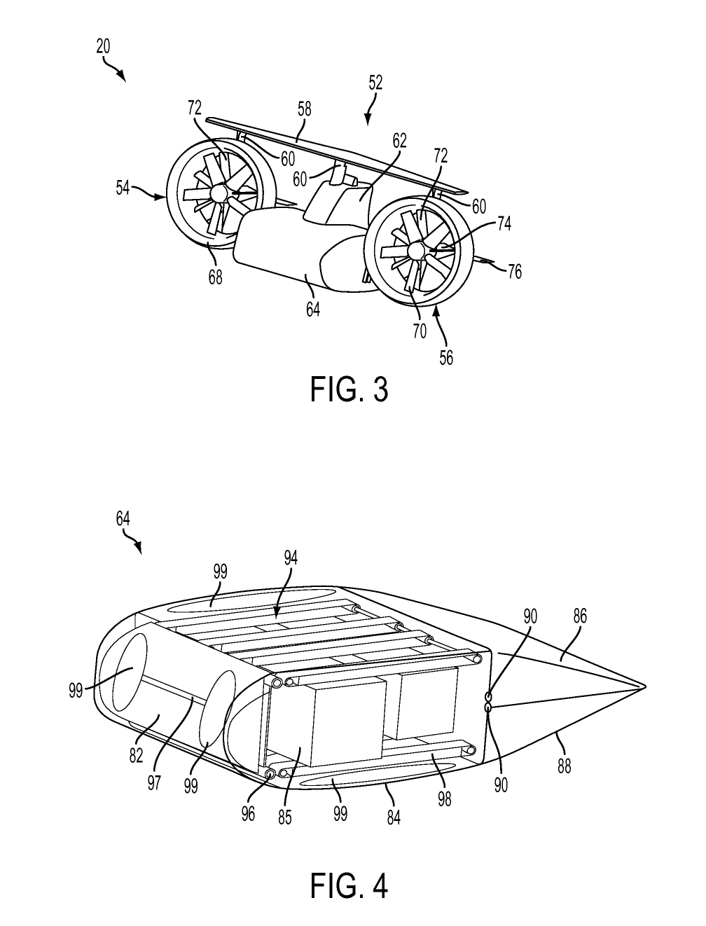

FIG. 3 illustrates an exemplary UAV 20 having a skeletal structure 52 including two ducted fan assemblies 54, 56 connected to an airfoil 58 via interconnects 60, a gas-powered turbine engine 62, and a cargo pod 64. Although not shown in the view set forth in FIG. 3, the UAV 20 may also include retractable rear-ward extending legs to allow for a vertical take-off and landing of the UAV 20.

Each fan assembly 54, 56 may include an outer hollow duct 68, a variable pitch fan 70, stator slipstreams 72, a tail cone 74, and tail vanes 76. The outer hollow duct 68 may be filled with fuel, or may include disparately placed fuel tanks for the dual purpose of storing petroleum-based fuel and participating in the center of gravity compensation procedure. The centrally placed turbine engine 62 may power the fans 70 via an intervening transmission system. Alternately, in place of the turbine engine 62, a battery power source may be provided to power electric motors placed within each fan assembly 54, 56. An electric motor could include, for example, a brushless direct current (DC) motor.

Upon rotation, the fans 70 generate an air flow through the ducts from a forward location to a rear location of the fan assembly 54, 56. A servo provided in the tail cone 74 may cause the tail vane 76 to rotate relative to the direction of airflow through the fan assemblies 54, 56. The tilt of the vanes 76 relative to the direction of airflow generates a change in outgoing thrust direction, causing the UAV 20 to move in a corresponding desired direction. The vanes 76 can be used to cause the UAV 20 to tilt from a vertical position to a horizontal position, at which time the airfoil 58 provides upward life during cruise.

Although FIG. 3 illustrates a cargo pod 64 rigidly and permanently attached to the skeletal structure 52 of the UAV 20, a detachable latching means could also be used to allow the cargo pod 64 to be removably attached to the skeletal structure 52 of the UAV 20.

Furthermore, although FIG. 3 references a double ducted hovering air-vehicle, it should be appreciated that the present embodiments have a broader applicability in the field of autonomous air-borne vehicles. Particular configurations discussed in examples can be varied and are cited to illustrate example embodiments only.

FIG. 4 sets forth a perspective view of an inner-structure of a cargo pod 64 according to one embodiment. As mentioned earlier, the cargo pod 64 is designed to allow for a plurality of partial deliveries of cargo provisions to two or more supply locations. Due to the high-speed horizontal cruise mode of the UAV 20, the cargo pod 64 must also maintain an aerodynamic profile to reduce wind drag at cruise speeds. Finally, the cargo pod 64 also must provide for autonomous ejection of partial payloads.

As shown in FIG. 4, a front end 82 of the cargo pod 64 may be formed of a rounded, semi-circular shape to improve air-flow over the front end of the pod 64 during high-speed cruise. The hollow mid-section 84 is formed to a particular length, width, and height dependent upon the space requirements for holding a plurality of cargo provisions 85 of varying shapes and sizes. Finally, a tail-end of the cargo pod 64 is provided with a pair of clamshell doors 86, 88 so as to provide for improved aerodynamics during high-speed flight, and to allow the cargo provisions 85 stored in the mid-section 84 to be ejected from the rear of the cargo pod 64 during delivery. The clamshell doors 86, 88 are hingedly connected to the rear of the mid-section via one or more hinges 90. The hinges 90 themselves may be further connected to a movable track so as to allow the clamshell doors 86, 88 to be moved towards the front end 82 of the cargo pod 64 while in the open position to increase a ground clearance of the cargo pod 64 when the UAV 20 is in a vertically landed position.

Inside the mid-section 84 of the cargo pod 64, a drive system 94 is disposed so as to allow the cargo provisions 85 to be loaded into the cargo pod 64, and to allow a center of gravity compensation procedure to be executed after a partial delivery of cargo provisions 85. The drive system 94 may comprise, for example, a belt system in which a plurality of rollers 96 secure diametrically opposed belts 98. Of course, other drive systems could also be used, including, for example, chain or screw drive mechanisms.

The cargo pod 64 may also contain one or more fuel tanks 99 disposed at disparate locations throughout the cargo pod 64. For example, two fuel tanks 99 may be formed at opposing lateral ends of the front end 82 of the cargo pod 64. Additional fuel tanks may be formed on inner or outer walls of the mid-section 84 of the cargo pod 64. The fuel tanks 99 may be interconnected via one or more liquid lines 97. The fuel tanks 99 in the cargo pod 64 may be further connected with the fuel tanks disposed in the hollow ducts 68 of the fan assemblies 54, 56 via additional liquid lines. The fuel tanks 99 may store fuel that may be burned by the UAV 20 during flight via a fuel line connection with the motor 62. One or more pumps (not shown) may be used to pump fuel from one fuel tank 99 to another under control of a control circuit.

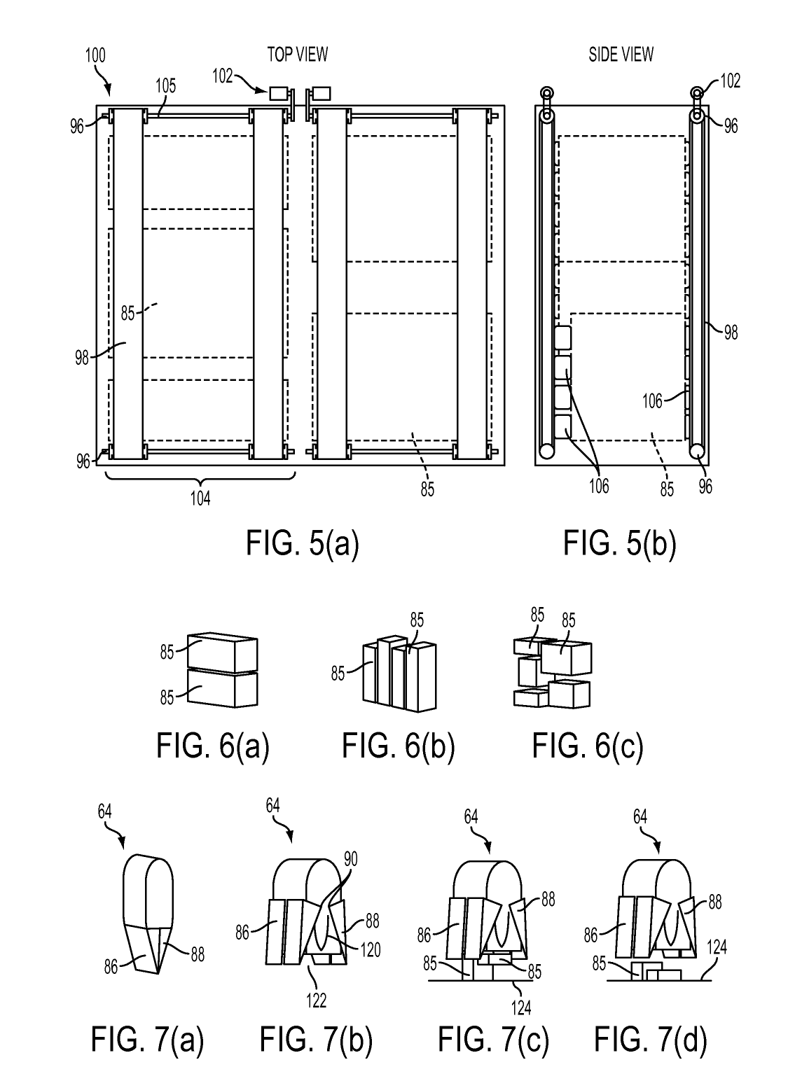

FIGS. 5(a) and 5(b) shows front and side views, respectively, of an example belt system 100 that may be contained within the cargo pod 64. Rollers 96 are provided at each lateral end of a belt 98. As shown in FIG. 5, four belts and eight rollers may provide a “column” of space 104 in which cargo provisions 85 may be loaded and stored. Adjacent rollers 96 in each “column” may be linked via an axle rod 105. Two electric motors 102 may be provided for each “column” of space 104 to allow a top two belts in a same plane and a bottom two belts in a same plane to be operated independently of one another. Other drive system configurations could also be used. For example, only two centrally-located, diametrically opposed belts could be provided per “column” of space 104. The configuration set forth in FIG. 5 is exemplary in nature only, and is not meant to limit the potential configurations of the drive system 94.

Each motor 102 may be individually driven to selectively rotate a corresponding belt 98, thereby causing cargo provisions 85 in contact with that belt 98 to move in the direction of the belt rotation. For example, during loading, the belts 98 in the side view portion of FIG. 5 may be rotated in the counter-clockwise direction to cause the cargo provisions 85 to move towards an upper portion of the cargo pod 64. Alternately, after the UAV 20 has arrived at a supply location and the doors 86, 88 of the cargo pod 64 have been opened, the belts 98 in the side view portion of FIG. 5 may be rotated in a clockwise direction to cause at least a portion of the cargo provisions 85 to fall out from a bottom of the cargo pod 64.

As set forth in FIG. 5, each belt 98 may also be provided with one or more squeeze actuators 106. The squeeze actuators 106 may be comprised of hollow rubber bladders that may be inflated via a liquid or gas to expand the size of the squeeze actuator until a sufficient pressure is placed on a cargo provision 85 to lift it into the cargo pod 64. A surface of the squeeze actuators facing the inside of the cargo pod 64 may also be formed to have a raised or depressed pattern in the surface to increase the friction between the belt 98 and a corresponding cargo provision 85.

Each pair of belts 98 and rollers 96 linked via rods 105 may be independently laterally moved in a direction towards the bottom of the cargo pod 64 and out of the mid-section 84 in order to aid in loading of cargo provisions 85. For example, a first pair of belts 98 and rollers 96 linked via rods 105 may be lowered to provide a backstop against which a loader could push a cargo provision 85. After the cargo provisions are placed against the backstop belts, the diametrically opposed pair of belts 98 and rollers 96 linked via rods 105 may be lowered to face the opposing side of the cargo provision 85, at which time squeeze actuators 106 on the belts 98 would inflate to apply sufficient pressure to the cargo provision 85. Then both pairs of belts 98 could be driven in a counter-clockwise manner (in the side view configuration of FIG. 5) to pull the cargo provision upwards towards the top of the cargo pod 64. Finally, the diametrically opposed pair of belts 98 and rollers 96 linked via rods 105 may be fully retracted back into the mid-section 84 of the cargo pod 64.

Although FIG. 5 sets forth a belt system 100 including belts 98 moving in a single parallel direction, other configurations could also be used. For example, additional belts could be disposed in a direction perpendicular to the direction of the belts 98 in FIG. 5 to allow the cargo provisions 85 to be moved in an alternate perpendicular direction. Other belt configurations could also be used, including diagonally-placed belts, for example.

FIGS. 6(a)-6(c) set forth example cargo provision 85 configurations supported by the cargo pod belt system 100 of FIG. 5. Of course, the configurations illustrated in FIGS. 6(a)-6(c) are for example purposes only. Actual cargo provision 85 configurations will depend upon the size of the cargo pod 64, the size and type of provisions 85, and the type and placement of the drive system 94, among other parameters.

As shown in FIG. 6(a), a first configuration may include a double full stack in which two cargo provisions 85 that extend across an entire width of the cargo pod 64 are stacked on top of one another in a vertical direction. In this configuration, a first partial payload delivery could be made at a first supply location by depositing the lower-most cargo provision 85 of FIG. 6(a). The upper-most cargo provision 85 remaining in FIG. 6(a) could then have its position re-adjusted during a center of gravity compensation procedure in order to maintain substantially a same center of gravity after the partial delivery as before the partial delivery.

As shown in FIG. 6(b), a second configuration may include a vertical stack in which four cargo provisions 85 extending substantially the entire vertical height of the cargo pod 64 are positioned adjacent one another in the width-wise direction of the cargo pod 64. The cargo provisions 85 may vary in overall height. In this configuration, a first partial payload delivery could be made at a first supply location by depositing the middle two cargo provision 85 of FIG. 6(b). The two out-side cargo provisions 85 remaining in FIG. 6(b) could then have their positions re-adjusted during a center of gravity compensation procedure in order to maintain substantially a same center of gravity after the partial delivery as before the partial delivery.

As shown in FIG. 6(c), a third configuration may include a variable load in which five cargo provisions 85 varying in both height and width are aggregated together to extend substantially the entire vertical height, width, and depth of the cargo pod 64. In this configuration, a first partial payload delivery could be made at a first supply location by depositing the two lower-most cargo provisions 85 (one from the left-side column and one from the right-side column) of FIG. 6(c). The three cargo provisions 85 remaining in FIG. 6(c) could then have their positions re-adjusted during a center of gravity compensation procedure in order to maintain substantially a same center of gravity after the partial delivery as before the partial delivery.

### iii. Operation of the UAV with Attached Autonomous Payload Parsing Management System and Structure

FIGS. 7(a)-7(d) set forth an example cargo provision 85 deposition procedure including a cargo pod 64 having cargo provisions 85 arranged in the variable load configuration of FIG. 6(c). FIG. 7(a) illustrates the positioning of the cargo pod 64 in a vertical-landed position just before or just after the UAV 20 lands at a first supply site. The clamshell doors 86, 88 may be opened while the UAV 20 is still in flight in order to increase a ground clearance below the cargo pod 64. Alternatively, if sufficient ground clearance exists, the clamshell doors 86, 88 may remain closed until after the UAV 20 has landed.

As shown in FIG. 7(b), the clamshell doors 86 and 88 positioned at the tail-end of the cargo pod 64 are rotated about their hinges 90 to reveal an opening 122 below the cargo pod 64 through which cargo provisions 85 stored within the cargo pod 64 may be ejected. As mentioned earlier, the hinge 90 of each clamshell door 86, 88 may move upwards along tracks 120 formed in side walls of the cargo pod 64 in order to increase the ground clearance between the bottom of the cargo pod 64 and the ground upon which the cargo provisions will be deposited.

After the clamshell doors 86, 88 have been opened, the drive system 94 may be activated to cause one or more cargo provisions 85 to be ejected through the opening 122. After the cargo provisions 85 have been ejected and delivered to a first supply destination 124, the UAV 20 may execute a center of gravity compensation procedure in which the remaining cargo provisions 85 are re-adjusted within the cargo pod 64 in order to maintain substantially a same center of gravity of the UAV 20 after the partial delivery in FIG. 7(c) as before the partial delivery. After the center of gravity compensation procedure is finished executing, the UAV 20 may depart the first supply destination 124, as shown in FIG. 7(d). The UAV 20 may then close the clam shell doors 86, 88 after taking flight to avoid interfering with the just-delivered cargo provisions 85. Although FIG. 7(d) shows the UAV 20 departing the first supply destination 124 prior to closing the clamshell doors 86, 88, the clamshell doors 86, 88 could be closed prior to departing if it is determined that sufficient clearance exists below the cargo pod 64 after the partial delivery.

While FIGS. 7(a)-7(d) illustrate delivery of cargo provisions 85 to a ground-based delivery site 124, it is equally possible to make mid-flight deliveries by opening the clamshell doors 86, 88 during horizontal cruise or vertical hovering and ejecting one or more cargo provisions 85 from the cargo pod 64. However, in this situation, center of gravity compensation procedures would need to be executed either during the ejection process or very shortly thereafter to maintain the UAV 20 in flight.

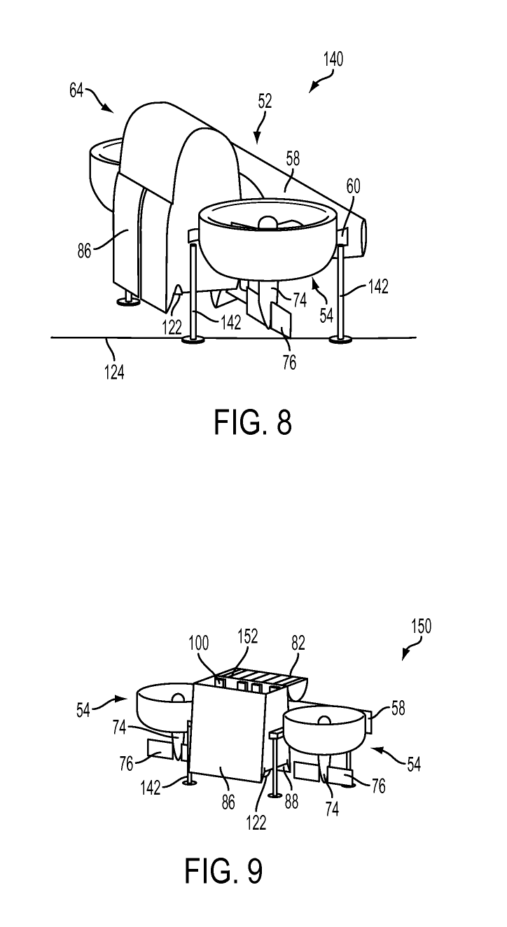

FIG. 8 illustrates a perspective view of a UAV 140 in a vertical landed position for making a partial delivery at the first supply destination 124. The UAV 140 contains substantially the same components as the UAV 20 of FIG. 3, and similar structural components are labeled with the same character references as FIG. 3 where applicable. In the vertical landed position of FIG. 8, however, four legs 142 are shown extending from the skeletal structural 52 of the UAV 140 to the ground of the first supply destination 124 in order to provide rigid support to the UAV 140 while in the landed position. The legs 142 may permanently be in the position shown in FIG. 8, or may telescope outwards for landing and recede inwards during flight in order to reduce drag on the UAV 140. The length of the (extended) legs 142 may also partially determine the ground clearance of the cargo pod 64 and thus the size of the opening 122 below the cargo pod 64. The length of the legs may be adjusted based on the pre-determined size of the cargo provisions 85 to be delivered from the cargo pod 64 at each supply location.

A UAV 150 according to one embodiment may be re-configured to a stowed position for storage, as shown in FIG. 9. For example, a hinge 152 placed between the mid-section 84 and the front end 82 of the cargo pod 64 may allow the front end 82 of the cargo pod 64 to be rotated approximately 180° to a position between an upper-surface side of the cargo pod 64 and the airfoil 58, reducing an overall height of the UAV 150 and thereby improving ease of transport. Additionally, the clamshell doors 86, 88 may be rotated into a fully-opened position and moved forward by causing the hinge 90 of each clamshell door 86, 88 to move along its track 120 towards the front of the cargo pod 64 (See FIG. 7(b)). In one embodiment, the UAV 150 may make partial deliveries by rotating the front end 82 open and driving the belt system 100 to cause cargo provisions 85 to be ejected from the top of the cargo pod 64 instead of the bottom.

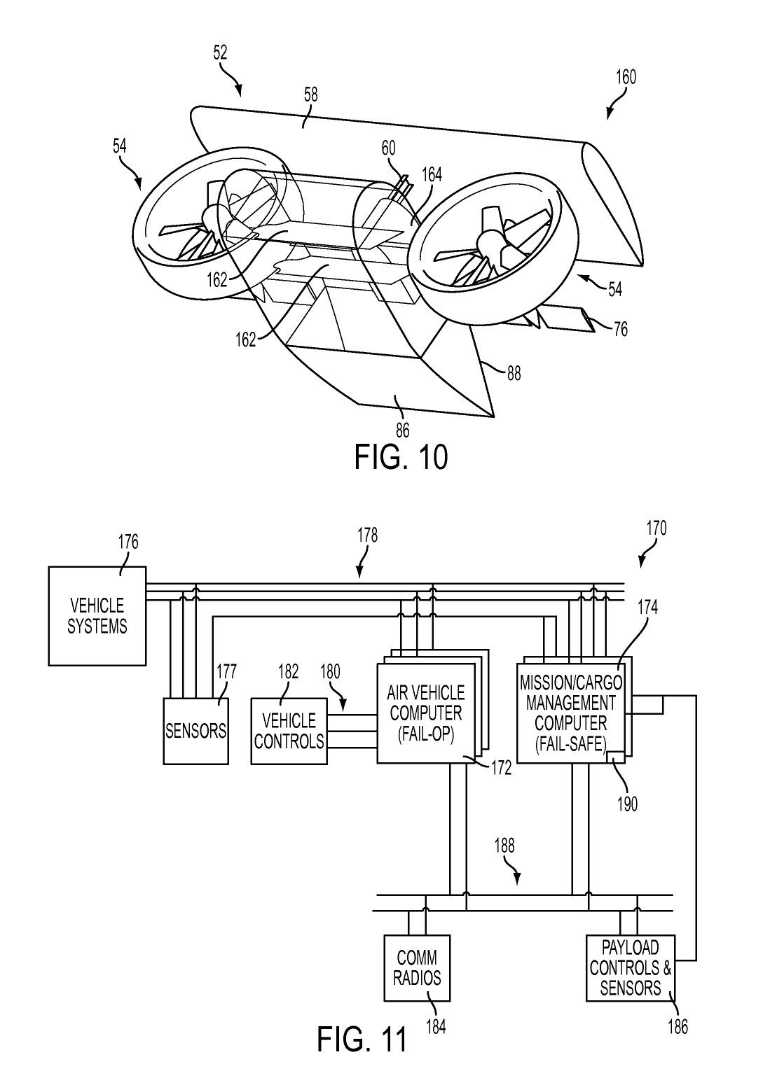

As mentioned in the description of FIG. 2 above, a UAV may alternately be loaded with a medical gurney in order to retrieve injured personal and return them to a medical facility that is better able to treat the injuries sustained. FIG. 10 sets forth an alternative embodiment of a UAV 160 including an arrangement of the cargo pod 64 that supports the inclusion of one or more medical gurneys 162. The medical gurneys 162 may be hingedly connected to an inside wall of the cargo pod 64 so as to maintain the gurneys 162, and thereby injured personal residing in the gurneys 162, in a horizontal position independent of the actual position of the UAV 160. In this manner, injured personnel could be retrieved from dangerous locations without imposing the same dangers on a rescue team attempting to extricate the injured from that dangerous location. Part of the gurney system may include life support and monitoring equipment to sustain life and provide telemetry to ground or ship based medical personnel, for example. As additional stops are made and additional injured picked up, the center of gravity compensation procedure can be executed to adjust a location of the one or more gurneys within the cargo pod 64 to maintain substantially a same center of gravity after picking up the additional injured as before picking up the additional injured.

### iv. Autonomous Payload Parsing Management System Control Architecture

FIG. 11 sets forth an example avionics architecture 170 for carrying out an autonomous payload parsing management system. Central components of the avionics architecture 170 include the air vehicle computer (AVC) 172 and the mission/cargo management computer (CMC) 174. Each AVC 172 module performs flight critical functions and may also interface with the CMC 174 to send and receive control data with the CMC 174.

More specifically, the AVC 172 may perform power control, flight control, engine/thrust control, take-off/approach/landing guidance, navigation and en-route guidance, and landing configuration control. In order to perform these functions, the AVC 172 has access to vehicle systems 176 such as engines, hydraulics, power distribution, ducted fan control vanes, etc. via input/output (I/O) bus 178. Additionally, the AVC 172 has access to sensor data 177 (e.g., pressure, altitude, temperature, inertial navigation sensing, GPS, LIDAR, etc.) via the same I/O bus 178. The AVC 172 may control UAV vehicle stability and direction via the I/O bus connection 180 to vehicle control systems 182. The AVC 172 is also connected to a communication radio 184 and payload controls and sensors 186 via I/O bus 188. The connection to the communication radio 184 allows for remote control of the UAV 20 and/or allows surveillance or status information to be reported back to a base station. As illustrated in FIG. 11, the AVC 172 may be designed in a triple redundant manner so as to prevent the failing of the UAV 20 due to a single fault in the AVC 172. In the event that one processor in the AVC 172 fails, a redundant processor may take over the processing to prevent catastrophic failure of the UAV 20. Other redundant architectures could be used in addition to, or in place of, the triple redundancy illustrated in FIG. 11. For example, a dual-dual redundancy could also be used.

Each CMC 174 implements the critical functions for loading/unloading the cargo pod 64, planning mission flights similar to that set forth in FIG. 2, landing zone assessment, and reporting and adjusting cargo provisions 85 contained within the cargo pod 64 in order to maintain a center of gravity of the UAV 20. The CMC 174 interfaces with the AVC 172 via I/O bus 178 in order to share information with the AVC 172. Similar to the AVC 172, the CMC 174 is also connected to the communication radio 184 and payload controls and sensors 186 via I/O bus 188. During loading, payload sensors 186 may provide the CMC 174 with a dynamic estimate of the weight impact to the center of gravity location. The connection to the payload controls and sensors 186 allows the CMC 174 to retrieve information regarding current positioning of the drive system 94, the current positioning of the cargo provisions 85, and, if available, a current status of fuel tanks placed disparately around the cargo pod 64. The CMC 174 may then use the estimate provided by the sensors 186, among other data, to adjust a position of the loaded cargo provisions 85 to achieve an optimum center of gravity. At this point in time, and if available, the CMC 174 may also re-adjust a location of fuel stored in the fuel tanks 99 to further optimize the center of gravity prior to take-off.

After arrival at a supply location, the CMC 174 may control the drive system 94 and the clamshell doors 86, 88 to effect partial delivery of cargo provisions 85 and subsequently control a second center of gravity compensation procedure including one or more of re-adjusting a position of the remaining cargo provisions 85 via the drive system 94 and re-adjusting a location of the fuel stored in the fuel tanks 99. After the center of gravity compensation procedure has been completed, the CMC 174 may signal to the AVC 172 that the compensation procedure has been completed, and that further flight to another supply destination may be resumed.

The CMC 174 may include a memory 190 for storing predetermined waypoints representing a mission flight plan to one or more supply destinations. While the UAV 20 is enroute, the CMC 174 may receive updated mission flight plans via the communications radio 184. Updated waypoint information may then be shared with the AVC 172 to allow the AVC 172 to compute new commands to vehicle systems 176 to cause the UAV 20 to reach the next computed waypoint. The CMC 174 may also update the mission plan based on collision avoidance signals received from the sensors 177 and provide the updated mission plan information to the AVC 172 to execute. Finally, the CMC 174 may receive imaging and radar sensor information from the sensors 177 during a landing process in order to determine whether it is clear to land at a particular supply destination, and to effectuate the landing of the UAV 20 at the particular supply destination.

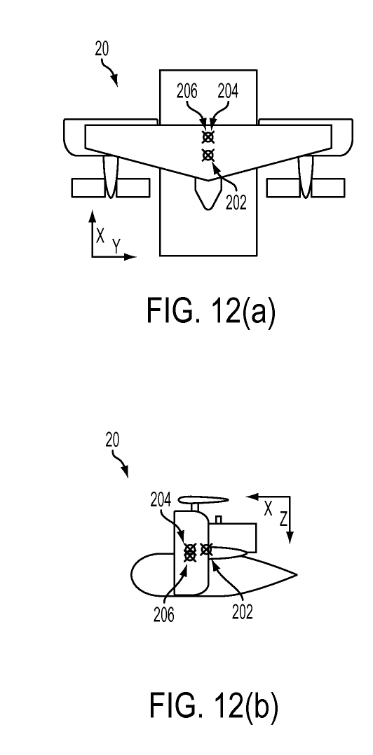

FIGS. 12(a)-12(b) illustrate top and side-views of center of gravity variances for a UAV 20 having different configurations. The center of gravity variations of FIGS. 12(a)-12(b) are prior to any center of gravity compensation procedure being executed at the UAV 20. FIG. 12(a) shows a top-view along the X-Y plane of changes in a center of gravity for the UAV 20 at full fuel, full payload 206, full fuel, no payload 204, and no fuel, no payload 202. As can be seen, there is substantially no center of gravity shift in the X-Y plane between the full fuel, full payload 206 configuration and the full fuel, no payload 204 configuration. In contrast, there is a center of gravity shift in the X-Y plane between the full fuel configurations 204, 206 and the no fuel, no payload configuration 202. The center of gravity shift occurs in the X direction and is approximately 14.5 inches.

FIG. 12(b) shows a side-view along the X-Z plane of changes in a center of gravity for the UAV 20 at full fuel, full payload 206, full fuel, no payload 204, and no fuel, no payload 202. As can be seen, there is substantially no center of gravity shift in the Z direction between the full fuel, no payload 204 configuration and the no fuel, no payload 202 configuration. In contrast, there is a center of gravity shift in the Z direction between the no payload configurations 202, 204 and the full fuel, full payload configuration 206. The center of gravity shift is approximately 5.4 inches in the Z direction.

While FIG. 12 only compares full payload to no payload, it is understood that symmetrical partial payloads would cause changes in center of gravity intermediate of a full payload and no payload. Additionally, asymmetrical partial payloads with uneven weights on one side of the cargo pod 64 could also cause varying changes in center of gravity in any one of the X, Y, or Z planes and is not illustrated in FIG. 12. The disclosed center of gravity compensation mechanisms may compensate for center of gravity variations in any one of the X, Y, or Z planes dependent upon the type of compensation mechanism used and its placement within the cargo pod 64.

Advantageously, the UAV 20 equipped with the drive system 100 of FIG. 5 and the control circuit 170 of FIG. 11 can compensate for the variations in center of gravity illustrated in FIGS. 12(a) and 12(b) by executing one or more center of gravity compensation adjustments including, but not limited to, adjusting positions of remaining cargo provisions 85 in the cargo pod 64 and pumping liquid from one fuel tank 99 to another. For example, in FIG. 12(a), the belt drive system 100 may be driven to cause cargo provisions within the cargo pod 64 to be moved rearward in the cargo pod 64. By moving the cargo provisions rear-ward, the center of gravity of the UAV 20 at full fuel, full payload would move backwards towards the no fuel, no payload 202 center of gravity. In FIG. 12(b), for example, fuel could be pumped from fuel tanks in bottom portions of the hollow duct 68 portions of the fan assemblies 54 to fuel tanks in upper portions of the hollow duct 68 portions of the fan assemblies 54. The movement of the fuel would cause the center of gravity at full fuel, full payload 206 to be moved upwards towards the center of gravity at full fuel no payload 204.

By compensating for center of gravity variations due to partial payload deliveries, a UAV 20 may make partial payload deliveries at a plurality of supply destinations, reducing potential injuries to personnel that previously conducted re-supply missions, and allowing for more frequent, more efficient, and quicker re-supply missions to be executed.

Note that while examples have been described in conjunction with present embodiments of the application, persons of skill in the art will appreciate that variations may be made without departure from the scope and spirit of the application. The true scope and spirit of the application is defined by the appended claims, which may be interpreted in light of the foregoing.

I claim:

1. An unmanned aerial vehicle (UAV) for making partial deliveries of cargo provisions, the UAV comprising:
one or more ducted fans;
a cargo pod comprising an outer aerodynamic shell and one or more drive systems for modifying a relative position of one or more cargo provisions contained within the cargo pod;
a structural interconnect connecting the one or more fans to the cargo pod; and
control logic configured to, after delivery of a partial portion of cargo provisions contained within the cargo pod, control the one or more drive systems to vary a position of at least a portion of remaining cargo provisions to maintain a substantially same center of gravity of the UAV after the delivery relative to a center of gravity of the UAV prior to the delivery.

2. The UAV according to claim 1, further comprising one or more fuel tanks disposed at disparate locations of the UAV, and wherein the control logic is further configured to re-distribute fuel amongst the fuel tanks after the delivery of a partial portion of the cargo provisions so as to maintain the substantially same center of gravity of the UAV after the delivery relative to the center of gravity prior to the delivery.

3. The UAV according to claim 1, wherein the one or more drive systems includes a belt drive system.

4. The UAV according to claim 3, wherein the belt drive system includes at least two diametrically-opposed belts disposed within the cargo pod, each belt including one or more squeeze actuators that may be increased or decreased in size to grip and hold a corresponding cargo provision.

5. The UAV according to claim 4, wherein a rear end of the cargo pod includes two opposed clam-shell doors hingedly connected to the cargo pod, the clam-shell doors being rotatable about the hinge between an open and closed position, and movable in a direction toward a front-end of the cargo pod.

6. The UAV according to claim 5, wherein the belt drive system is movable in a direction toward the rear end of the cargo pod.

7. The UAV according to claim 5, wherein a forward end of the cargo pod includes a rounded edge in order to reduce aerodynamic drag while the UAV is in a horizontal cruise flight mode.

8. The UAV according to claim 4, wherein the belt drive system includes two sets of two diametrically-opposed belts within the cargo pod, each belt including one or more squeeze actuators that may be increased or decreased in size as necessary in order to grip and hold a corresponding cargo provision.

9. The UAV according to claim 1, wherein the UAV is capable of vertical take-off and landing (VTOL), and the UAV further includes an airfoil attached to said structural interconnect to support a horizontal flight position during cruise.

10. A method of autonomously making deliveries via an unmanned aerial vehicle (UAV) comprising:
a UAV flying to a first supply destination, the UAV having one or more ducted fans and a structural interconnect connecting the one or more ducted fans to a cargo pod, the cargo pod having an outer aerodynamic shell and one or more drive systems for modifying a relative position of one or more cargo provisions contained within the cargo pod; and
the UAV landing in a vertical position at the first supply destination;
the UAV opening a portion of the cargo pod and depositing a portion of the cargo provisions contained within the cargo pod;
the UAV varying a position of at least a portion of remaining cargo provisions so as to maintain a substantially same center of gravity of the UAV after the delivery relative to a center of gravity of the UAV prior to the delivery.

11. The method according to claim 10, wherein the UAV further comprises one or more fuel tanks disposed at disparate locations of the UAV; and the method further comprising re-distributing a fuel amongst the fuel tanks after depositing a portion of the cargo provisions so as to maintain the substantially same center of gravity of the UAV after the delivery relative to the center of gravity of the UAV prior to delivery.

12. The method according to claim 10, wherein the UAV varies a position of the remaining cargo provisions by driving one or more belts in a belt drive system.

13. The method according to claim 12, wherein the belt drive system includes at least two diametrically-opposed belts disposed within the cargo pod, each belt including one or more squeeze actuators that may be increased or decreased in size to grip and hold a corresponding cargo provision, and wherein the method further comprises depositing the portion of the cargo provisions by decreasing a size of corresponding squeeze actuators to release the portion of the cargo provisions from the cargo pod.

14. The method according to claim 12, wherein a rear end of the cargo pod includes two opposed clam-shell doors hingedly connected to the cargo pod, and wherein the method further comprises depositing the portion of the cargo provisions by rotating the clam-shell doors about the hinge from a closed position to an open position, and moving the doors in a direction towards a front-end of the cargo pod to increase a ground clearance between the ground and the rear portion of the cargo pod when in a vertical position.

15. The method according to claim 12, wherein the belt drive system is extended in a direction toward the rear end of the cargo pod prior to depositing the portion of the cargo provisions.

16. The method according to claim 10, wherein a forward end of the cargo pod includes a rounded edge in order to reduce aerodynamic drag while the UAV is in a horizontal cruise flight mode.

17. The method according to claim 12, wherein the belt drive system includes two sets of two diametrically-opposed belts within the cargo pod, each belt including one or more squeeze actuators that may be increased or decreased in size grip and hold a corresponding cargo provision.

18. The method according to claim 10, wherein the UAV is capable of vertical take-off and landing (VTOL), and the UAV further includes an airfoil attached to said structural interconnect to additionally support a horizontal flight position during the flying to the first supply destination.

19. The method according to claim 10, further comprising taking-off from the first supply destination and subsequently closing the portion of the cargo pod.

20. The method according to claim 10, further comprising closing the portion of the cargo pod and subsequently taking-off from the first supply destination.
